(19) United States
(12) Patent Application Publication
(10) Pub. No.: US 2008/0125292 A1
(43) Pub. Date: May 29, 2008

(54) Running machine belt

(75) Inventor: Seiichiro Simazu, Tokyo (JP)

Correspondence Address: BUCHANAN, INGERSOLL & ROONEY PC, POST OFFICE BOX 1404, ALEXANDRIA, VA, 22313-1404, US

(73) Assignee: Kokushin Sangyo Kabushiki Kaisha, Tokyo (JP)

(21) Appl. No.: 11/984,393

(22) Filed: Nov. 16, 2007

(30) Foreign Application Priority Data
Nov. 29, 2006 (JP) 2006-321391

(51) Int. Cl. A63B 22/02; B65G 15/30

(52) U.S. Cl. 482/54; 198/844.1; 474/237

(57) ABSTRACT

A running machine belt is a belt rotated by a driving roller of a running machine main body. The running machine belt is formed in an endless shape and in width enough for allowing a person to stand thereon. The running machine belt includes a core belt formed of at least one kind of fiber material, a soft layer provided on a front surface of the core belt on which the person stands, and a graphite paint layer provided on a rear surface of the core belt that comes into contact with the driving roller.

### BACKGROUND OF THE INVENTION

1. Field of the Invention

The present invention relates to a belt used in a running machine that allows a user to walk and run to improve health and physical strength.

2. Description of Related Art

In the past, a running machine belt is formed in an endless shape, wound and suspended around a driving roller and a driven roller of a running machine main body, and guided by a bearing member, which is provided between the driving roller and the driven roller, not to bend even if a person stands thereon (see, for example, Japanese Patent No. 3040346). In the running machine belt of this type, when a running machine is driven, it is likely that a rear surface of the running machine belt comes into slide contact with the bearing member and the rollers and the running machine belt is electrostatically charged. In particular, when a person stands on the running machine and starts walking or running, a rear surface of the running machine belt comes into slide contact with the bearing member while coming into press contact therewith because of weight shift involved in the walking or the running. As a result, far larger static electricity is generated. When the running machine belt is electrostatically charged, a control device that controls the running machine malfunctions or fails. A person who touches the running machine feels uncomfortable. Therefore, antistatic measures are applied to the running machine belt. In the running machine belt in the past, conductive strings are provided on the rear side as the antistatic measures (see, for example, Japanese Utility Model Registration No. 2568369).

In the running machine belt in the past, as described above, when a person stands thereon and starts walking or running, a load is repeated applied to the running machine belt, the conductive strings are cut, and the charging preventive effect is substantially damaged. When the conductive strings are cut, since it is difficult to repair the conductive strings, there is no alternative but to discard the running machine belt.

### SUMMARY OF THE INVENTION

The present invention has been device in view of the problems and it is an object of the present invention to provide a running machine belt that can maintain the antistatic effect for a long period and is excellent in durability and functionality.

A running machine belt according to a first aspect of the present invention is a running machine belt rotated by a driving roller of a running machine main body. The running machine belt is formed in an endless shape and in width enough for allowing a person to stand thereon. The running machine belt includes a core belt formed of at least one kind of fiber material, a soft layer provided on a front surface of the core belt on which the person stands, and a graphite paint layer provided on a rear surface of the core belt that comes into contact with the driving roller.

According to a second aspect of the present invention, the graphite paint layer includes at least graphite powder and thermoplastic resin that holds the graphite powder.

### BRIEF DESCRIPTION OF THE DRAWINGS

FIG. 1 is an overall perspective view of a running machine attached with a running machine belt according to an embodiment of the present invention;

FIG. 2 is a sectional side view of a main part of the running machine in FIG. 1; and

FIG. 3 is a sectional view of a main part of the running machine belt.

### DESCRIPTION OF THE EMBODIMENTS

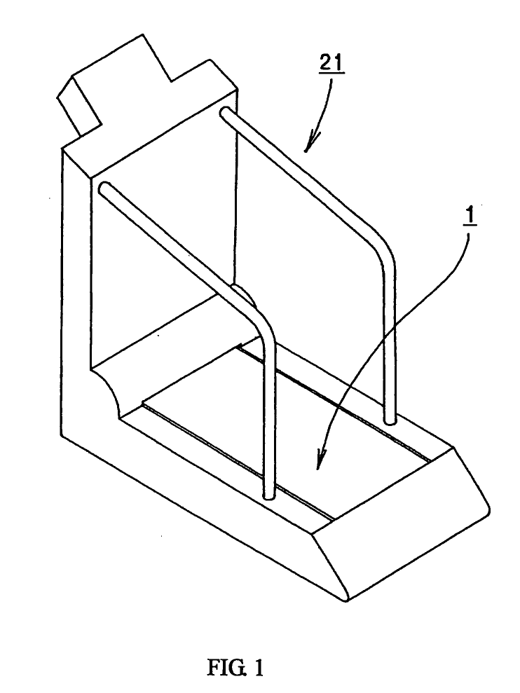

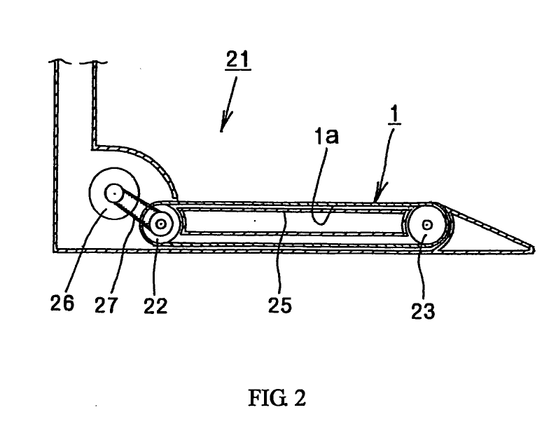

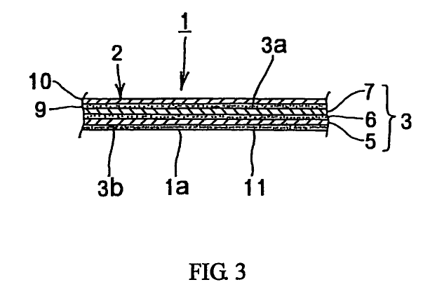

A running machine belt according to an embodiment of the present invention is explained below with reference to FIGS. 1 to 3. FIG. 1 is an overall perspective view of a running machine attached with the running machine belt according to this embodiment. FIG. 2 is a sectional side view of a main part of the running machine. FIG. 3 is a sectional view of a main part of the running machine belt.

A running machine belt 1 is a running machine belt rotated by a driving roller 22 of a main body 21 of a running machine (a running machine main body 21). The running machine belt 1 is formed in an endless shape and in width enough for allowing a person to stand thereon. The running machine belt 1 includes a core belt 3 formed of at least one kind of fiber material, a soft layer 10 provided on a front surface 3a of the core belt 3 on which the person stands, and a graphite paint layer 11 provided on a rear surface 3b of the core belt 3 that comes into contact with the driving roller 22. The graphite paint layer 11 includes at least graphite powder and thermoplastic resin that holds the graphite powder.

The running machine belt 1 is explained in detail. The running machine belt 1 is formed in an endless shape and in width enough for allowing a person to walk and run thereon. Specifically, the running machine belt 1 is formed in a size with the total length of about 3400 mm, the width of about 530 mm, and the thickness of about 3.5 mm. The running machine belt 1 includes a belt main body 2 and the graphite paint layer 11 provided on the rear surface 3b of the belt main body 2. The belt main body 2 includes the core belt 3 and the soft layer 10 provided on the front surface 3a of the core belt 3.

The core belt 3 is formed by stacked plural fiber layers such as a polyester fiber layer and a polyamide fiber layer. Specifically, the core belt 3 includes a white polyester fiber layer 5 and a polyester fiber layer 7 fixed on an upper surface of the polyester fiber layer 5 by an adhesive 6. The core belt 3 may be one fiber layer, for example, the polyester fiber layer 5. The soft layer 10 is fixed to the upper surface (the front surface) 3a of the polyester fiber layer 7 (the core belt 3) by an adhesive 9. In this embodiment, the soft layer 10 is a black polyvinyl chloride (PVC) layer 10. However, the soft layer 10 is not limited to this and may be a rubber layer.

The graphite paint layer 11 is provided on the rear surface 3b of the polyester fiber layer 5 (the core belt 3). Black paint forming the graphite paint layer 11 is obtained by mixing graphite powder, thermoplastic resin, carbon black (a hardener), and dioxolane (a thinner) at a predetermined blending ratio. The thermoplastic resin is vinyl chloride, polyethylene, or polypropylene and plays a role of firmly holding the graphite powder. The graphite paint is applied to the rear surface 3b of the polyester fiber layer 5 (the core belt 3) at the thickness of about 0.4 mm to 0.6 mm. The graphite paint is air-dried for a predetermined time to form the graphite paint layer 11. Means for applying the graphite paint may be general means such as silk printing, gravure printing, direct coating by a brush, and spraying and is not specifically limited. A drying time is about 3 to 6 hours but may be changed according to temperature, humidity, and the like during the drying and is not specifically limited. The graphite paint layer 11 is formed by impregnating the graphite paint in gaps of polyester fibers. Thus, the graphite paint layer 11 does not easily peel off from the polyester fiber layer 5 (the core belt 3). The graphite paint is excellent in electrical conductivity, lubricity, thermal conductivity, heat resistance, and chemical resistance.

The running machine belt 1 is attached to the running machine main body 21 in the same manner as the belt in the past. The running machine main body 21 includes a driving roller 22, a driven roller 23, a bearing member 25 arranged between the driving roller 22 and the driven roller 23, and a driving motor 26 that rotates the driving roller 22 via a belt 27. the running machine belt 1 is wound and suspended around the driving roller 22 and the driven roller 23 of the running machine main body 21 and guided by the bearing member 25 not to bend even if a person stand thereon. Although not shown in the figure, a switch for turning on and off the driving motor 26 and an operation panel for setting a driving time and rotation speed of the driving motor 26 are provided in the running machine main body 21.

In the running machine main body 21, when the switch is turned on, the driving motor 26 is driven and the driving roller 22 rotates via the belt 27. When the driving roller 22 rotates, the running machine belt 1 rotates. When a person stands on the running machine belt 1, the running machine belt 1 bends under the weight of the person. The rear surface 1a comes into press contact with the bearing member 25 and further comes into slide contact with the bearing member 25. The running machine belt is pulled by the driving roller 22 to rotate. When a person stands on the running machine belt 1, the running machine belt 1 comes into press contact with the bearing member 25 and a load is applied to the running machine belt 1. Thus, the rear surface 1a may slide on the driving roller 22. In this way, the rear surface 1a of the running machine belt 1, i.e., the surface 1a of the graphite paint layer 11 slides on the bearing member 25 and the driving roller 22. When the rear surface 1a slides, electrostatic electricity is generated. However, since the graphite paint layer 11 has electrical conductivity, it is possible to prevent electrostatic charging. Since the graphite paint layer 22 has lubricity, a frictional resistance with the bearing member 25 in contact with the graphite paint layer 11 is small. Therefore, static electricity is rarely generated and a load applied to the running machine belt 1 is small. Consequently, it is possible to reduce a load on the driving motor 26 and substantially improve the durable life of the driving motor 26.

When a person stands and runs on the running machine belt 1, the weight of the person is frequently applied to the running machine belt 1 via the soles of the feet locally and alternately. Therefore, the rear surface 1a of the running machine belt 1, i.e., the surface 1a of the graphite paint layer 11 impulsively comes into press contact with the bearing member 25. The rear surface 1a of the running machine belt 1, i.e., the surface 1a of the graphite paint layer 11 comes into slide contact with the bearing member 25 simultaneously with the press contact. Moreover, since the weight of the person is applied via the soles of the feet alternately, the running machine belt 1, i.e., the graphite paint layer 11 is vigorously expanded and contracted. Therefore, the running machine belt 1 is placed under conditions severer than conditions under which a normal conveyor belt not frequently applied with an impulsive load is placed. If a normal paint layer is used in the running machine belt 1, the normal paint layer easily peels off. However, as described above, in the running machine belt 1, since the thermoplastic resin that firmly holds the graphite powder is blended in the graphite paint layer 11, the graphite paint layer 11 less easily peels off even under the severer conditions. Consequently, the running machine belt 1 is excellent is the antistatic effect, lubricity, and durability and can be used for a long period.

As described above, in the running machine belt 1, since the thermoplastic resin that firmly holds the graphite powder is blended in the graphite plaint layer 11, it is possible to prevent the graphite paint layer 11 from easily peeling off. Therefore, unlike the mere conveyor belt, in particular, when an impulsive load is frequently applied to the running machine belt 1 as in the running machine, the running machine belt 1 can withstand use for a long period.

In the running machine belt 1, the graphite paint layer 11 is provided on the rear surface 3b of the core belt 3. The surface 1a of the graphite paint layer 11 comes into slide contact with the bearing member 25 and the roller 22 to generate static electricity. However, since the graphite paint layer 11 has electrical conductivity, the graphite paint layer 11 is useful for prevention of electrostatic charging. Since the graphite paint layer 11 is not cut unlike the conductive strings in the past, the antistatic effect can be maintained for a long period. Since the graphite paint layer 11 has a small frictional resistance and is slippery, the graphite paint layer 11 is excellent in abrasion resistance and can be used for a long period.

The running machine belt according to the present invention can be used in a running machine that allows a user to walk and run to improve health and physical strength.

In the running machine belt according to the present invention, the graphite paint layer is provided on the rear surface of the core belt and comes into slide contact with the bearing member and the rollers. Since the graphite paint layer has electrical conductivity, there is the effect that the graphite paint layer is useful for prevention of electrostatic charging. Since the graphite paint layer is not cut unlike the conductive strings in the past, there is the effect that the antistatic effect can be maintained for a long period. Since the graphite paint layer has a small frictional resistance and is slippery, the graphite paint layer is excellent in abrasion resistance. Since the graphite paint layer provided on the rear surface of the core belt and having the effects described above comes into slide contact with the bearing member and the rollers, there is the effect that the running machine belt according to the present invention is excellent in durability and functionality and can be used for a long period.

Since the thermoplastic resin that firmly holds the graphite powder is blended, it is possible to prevent the graphite paint layer from easily peeling off. Therefore, there is the effect that it is possible to provide a running machine belt that can withstand use for a long period even when, unlike a mere conveyor belt, the running machine belt is used in a running machine to which an impulsive load is frequently applied.

What is claimed is:

1. A running machine belt rotated by a driving roller of a running machine main body and formed in an endless shape and in width enough for allowing a person to stand thereon, the running machine belt comprising:
a core belt formed of at least one kind of fiber material;
a soft layer provided on a front surface of the core belt on which the person stand; and
a graphite paint layer provided on a rear surface of the core belt that comes into contact with the driving roller.

2. A running machine belt according to claim 1, wherein the graphite paint layer includes at least graphite powder and thermoplastic resin that holds the graphite powder.
